(19) United States
(12) Patent Application Publication
(10) Pub. No.: US 2014/0149305 A1
(43) Pub. Date: May 29, 2014

(54) PASSENGER TRACKING

(71) Applicants: Adnan Aziz, Sterling, VA (US); Amir Faizi, Boyds, MD (US); Howard Lossing, Potomac, MD (US)

(72) Inventors: Adnan Aziz, Sterling, VA (US); Amir Faizi, Boyds, MD (US); Howard Lossing, Potomac, MD (US)

(21) Appl. No.: 14/059,129

(22) Filed: Oct. 21, 2013

Related U.S. Application Data
(60) Provisional application No. 61/716,814, filed on Oct. 22, 2012.

(51) Int. Cl. G06Q 50/20; G06Q 10/06

(52) U.S. Cl. CPC G06Q 50/20; G06Q 10/063
USPC 705/326

(57) ABSTRACT

According to some examples, vehicles may be guided along a path including multiple waypoints and stop points that are sequentially submitted to a routing application. Instructions associated with the waypoints and stop points may be presented on a display to assist in guiding the vehicle along the path. According to other examples, people boarding and/or getting off the vehicle may be tracked.

### Related Applications

This application claims priority to Provisional Application No. 61/716,814, entitled “REAL-TIME ON-BOARD STUDENT TRANSPORTATION TRACKING (OSTT)” filed on Oct. 22, 2012, the entire contents of which are incorporated herein by reference in its entirety.

### DETAILED DESCRIPTION

### Background

Fleet management software may be used to manage fleets of vehicles, for example, trucks. Fleet management software may incorporate functionality that tracks trucks and maps their location on a map. Locations of trucks may be obtained via global positioning systems (GPS) devices installed in the trucks. GPS devices may further capture location and speed information. The captured information may be transmitted to an administrative device where an administrator may monitor location, speed and routes of trucks in a fleet.

### BRIEF DESCRIPTION OF THE DRAWINGS

The accompanying drawings, which are incorporated in and constitute a part of this specification, illustrate, together with the description, examples of the present disclosure. In the figures:

FIG. 1 is an example system environment, in accordance with one or more examples disclosed herein;

FIG. 2A is an example block diagram of components included in a computing device in a vehicle, in accordance with one or more examples disclosed herein;

FIG. 2B is an example diagram depicting a table structure stored at a computing device, in accordance with one or more examples disclosed herein;

FIG. 3 is an example block diagram of components included in a navigation application, in accordance with one or more examples disclosed herein;

FIG. 4 is an example flow diagram of a method for guiding a vehicle, in accordance with one or more examples disclosed herein;

FIG. 5 is an example screen display that may be displayed on a display device, in accordance with one or more examples as discussed herein;

FIG. 6 is an example block diagram depicting components of a student tracking application, in accordance with one or more examples as discussed herein;

FIG. 7 is an example user interface that may be presented on a display device, in accordance with one or more examples as discussed herein;

FIG. 8 is an example flow diagram of a process for providing a user interface, in accordance with one more examples as discussed herein;

FIG. 9 is an example block diagram depicting components included in a synchronization application, in accordance with one or more examples as discussed herein;

FIG.. 10 depicts an example diagram depicting events that affect frequency of sending messages, in accordance with one or more examples as discussed herein;

FIG. 11 depicts an example format of a message, in accordance with one or more examples as discussed herein;

FIG. 12 depicts a block diagram of components in a hub, in accordance with one or more examples as discussed herein;

FIG. 13 depicts an example screen display of a dashboard, in accordance with one or more examples as discussed herein;

FIG. 14 depicts an example disclosure of a user interface for monitoring, in accordance with one or more examples as discussed herein;

FIG. 15 depicts an example disclosure of a user interface for managing information, in accordance with one or more examples as discussed herein; and

FIG. 16 is an example computer system or apparatus that may be used as a platform for executing the functionality discussed herein.

### DETAILED DESCRIPTION

Drivers of vehicles generally do not have real-time or routinely updated access to ridership and predefined routes. For example, in the case of school bus drivers, drivers may have access to printed rosters with anticipated ridership, but as rosters change, and students are added or removed from the roster, the drivers may not have access to this information in a timely fashion.

In addition, drivers may not easily match a roster of students with the students that are boarding the bus. A driver may drive multiple runs for each route driven. Each run may have multiple stops and h stop may have multiple students that are expected to board the bus. Thus, it may be difficult for the driver to ensure that the correct students are boarding the bus, and boarding the bus at the proper bus stop location.

Further, without updated and accurate ridership schedules, it may be difficult to optimize the runs and routes the drivers drive, thereby potentially expending unnecessary fuel, time, and wear on the vehicle.

As provided herein, according to some examples, real-time routing may be provided by accessing a plurality of waypoints and a plurality of stop points, the plurality of waypoints and the plurality of stop points defining a route from a starting location to an ending location; sequentially submitting the plurality of waypoints and the plurality of stop points, in an order, to a routing application as destination points; and displaying, on a display, a map including an indication of a path from a current location to a destination point.

According to some examples, an apparatus is provided including a route manager to select a plurality of waypoints and a plurality of stop points and to sequentially submit each of the selected plurality of waypoints and the plurality of stop points as destination points into a routing application, wherein the plurality of waypoints and the plurality of stop points define a route from a starting point to an ending point: and a monitor to monitor location information received from a global positioning system (GPS) receiver and to initiate submission of waypoints and stop points by the route manager based on the location information received from the GPS receiver.

According to some examples, real-time routing may be provided to navigate a vehicle from a starting point to an ending point via a plurality of waypoints and a plurality of stop points by sequentially submitting the plurality of waypoints and the plurality of stop points, in an order, to a routing application as destination points; and display, on a display, a map including an indication of a path from a current location to a submitted waypoint or a submitted stop point and to display text-based instructions to the destination point.

According to some examples, student tracking ray be provided by determining a location of a vehicle traveling along a vehicle run; selecting a set of objects based on the determined location; displaying, on a display device, the selected set of objects; and providing, on the display device, a user interface to receive input related to each of the objects in the set of objects.

According to some examples, an apparatus may be provided including a storage to store a plurality of sets of objects, each of the objects representing a person and each of the objects associated with a location; a tracking module to track whether each of the objects boards a vehicle at the location associated with each of the objects; and an interface to display a set of objects associated with a location of a vehicle and to receive an indication indicating one or more objects have boarded the vehicle.

According to some examples, student tracking is provided to manage a status of a plurality of sets of objects, each of the objects representing a person scheduled to board a vehicle, wherein the status indicates whether a person boarded a vehicle and, if the person boarded the vehicle, where the person boarded the vehicle; and provide an interface to display a set of objects based on a location of the vehicle, the interface configured to receive an indication of one or more of objects in the set of objects whether the person boarded the vehicle.

According to some examples, efficient communication transfer is provided to transfer sets of data and to select an amount and/or type of data and select and/or adjust a timing in which to transfer the data based on a current state of a vehicle.

### System Environment

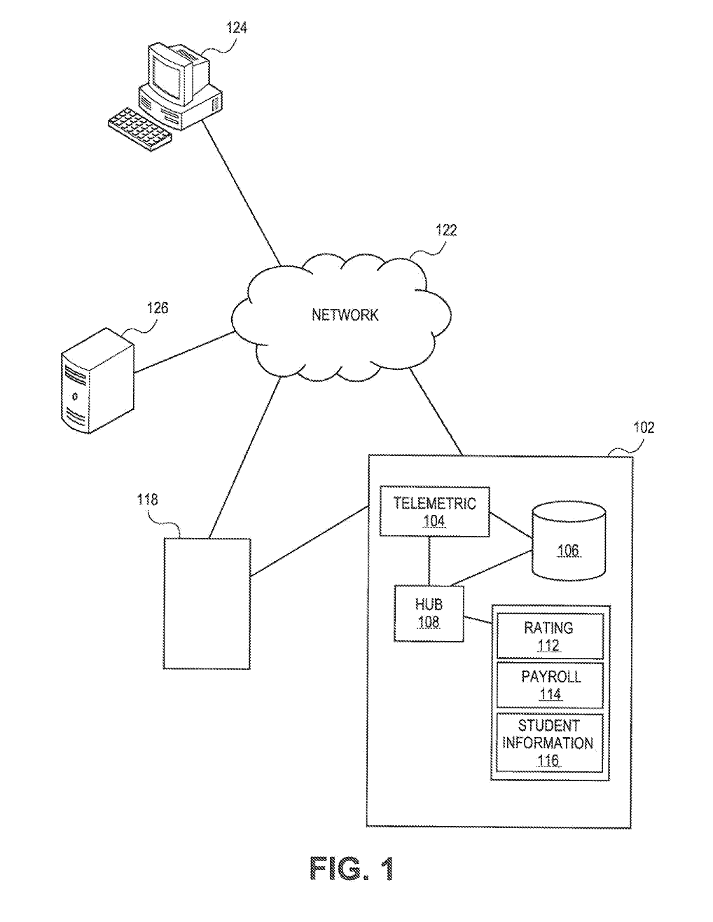

FIG. 1 depicts a system environment for implementing the functionality as discussed herein As shown in FIG. 1, system environment 100 may include administrative device 102. Administrative device 102 may be implemented as a single device having multiple components or multiple devices that are co-located or remote from each other. Administrative device 102 includes telemetric device 104, database 106, hub 108 and school device 110. School device 110 includes routing device 112, payroll device 114 and student information 116.

Administrative device 102 may be communicably linked to network 122 to communicate with one or more client, devices 124, for example, operated by parents of students. Administrative device 102 may further be communicably linked to computing device 118 that may be located, for example, inside a vehicle, for example, a bus or any other type of vehicle responsible for traveling a route, transporting passengers, or tracking items. Administrative device 102 may be communicably linked to computing device via network 122, via a local area network, wired or wireless, through a cellular network, etc.

Telemetric device 104 may be implemented as, for example, a UDP communications device, or other type of device, and may transmit data to, and receive data from, computing device 118. Data received from computing device 118 may be stored in storage 106. Storage 106 may be implemented as one or more databases located either within administrative device 102 or remote from, and communicably linked to administrative device 102.

Database 106 may comprise one or more databases and stores information received from computing device 118. Information stored in database 106 may be accessed by telemetric device 104, hub 108, etc. In some examples, database 106 may be an Oracle database, or other relational databases.

School device 110 may include information specific to a particular school, school district, region, etc. School device 110 may include routing device 112. Routing device 112 may include information related to routes of vehicles for the school, school district, region, etc. A route may include one or more runs. A run may include one or more stops. A run may be defined by a series of latitude/longitude (lat/long) coordinates of waypoints and stops that form a specific path a vehicle should take from a starting point to an ending point. Waypoints may represent specific locations where a driver is to take an action to keep the vehicle on the path of the run. For example, waypoints may represent a left turn, a right turn, an instruction to proceed straight, a U-turn, etc. Stop points may represent specific locations where students are to board or get off of, or de-board, a vehicle. Routing device 112 may manage one or more runs for a route and may further manage one or more routes. Hub 108 may access run and route information from routing device 112 and transmit the information, via telemetric device 104 to computing device 118 on vehicle 120. The run and route information may direct the driver, in real-time along the runs and route in order to pick up and drop off passengers according to the routing information from routing device 112.

Payroll device 114 may manage payroll information of employees working for the school, school district, etc. Payroll information may be calculated, for example, based on information input at device 118.

Student information 116 may store information associated students enrolled in the school, school district, etc. For example, for each student, student information 116 may store, in association with the student name, one or more of the student's address, the location, for example, the lat/long coordinates, of where the student is to board the vehicle, the lat/long coordinates of where the student is to get off the vehicle, identifying information of the run and route the student is assigned to when the student is picked up to go to school, identifying information of the route and run the student is assigned when the student is dropped off from school, a home address of the student, an emergency contact number for the student, medication the student is taking, any special instructions to be presented to a driver of the vehicle when the student is either getting on the vehicle or getting off the vehicle, etc.

Hub device 108 may access student information from student information device 116 and transmit the information, via telemetric device 104 to computing device 118 on vehicle 120. The one or more pieces of information associated with the students may be presented to the driver, in real-time, along the runs and route in order to track student boarding and/or de-boarding as more fully discussed below.

It may be appreciated that the functionality described herein supports tracking of student de-boarding in the same manner as the student boarding vehicles.

Administrative device 102 may be implemented as a server, a mainframe computer, any combination of these components, or any other appropriate computing device, resource service, for example, cloud, etc. Administrative device 102 may be standalone, or may be part of a subsystem, which may, in turn, be part of a larger system. It may be appreciated that, while device 102 may be described as including various components, one or more of the components may be located at other devices (not shown) within system environment 100.

Client device 124 may be implemented as any computing device, for example, a desktop computer, laptop computer portable computing device, etc. Client device 124 may be operated by one or more parents of students in order to access, via network 122, real-time information as collected and discussed herein.

Computing device 118 may include one or more of a student tracking module, a navigation module, a synchronization module, and/or other modules as discussed herein. Computing device 118 may be operational in vehicle 120 in such a manner that a driver of the vehicle may interact with computing device 118. According to some examples, computing device 118 may be implemented in a manner sufficient that a driver of vehicle may receive instructions related to the runs and routes, and/or students boarding or getting off the vehicle in real-time. Components of computing device 118 are further discussed below.

Cellular provider 126 may be communicably linked to computing device 118, wherein cellular provider may provide data usage information to computing device 118, and/or administrative device 102. This functionality is more fully discussed below.

Additionally, devices 102, 124, 126, and 118 include the necessary hardware and/or software needed to communicate with the network 122 via a wired and/or a wireless connection. Device 102, 102, 124, 126, and 118 may be embodied by server computing devices, desktop/laptop/handheld computers, wireless communication devices, personal digital assistants or any other similar devices having the necessary processing and communication capabilities. In an embodiment, the network 122 may comprise a public communication network such as the Internet or World Wide Web and/or a private communication network such as a local area network (LAN), wide area network (WAN), etc.

One or more of devices 102, 124, 126, and 118 may comprise one or more suitable computing devices to implement the functionality as discussed herein.

As discussed herein, devices 102, 124, 126, and 118 include one or more processors in communication with one or snore storage devices. The processor(s) may comprise a microprocessor, microcontroller, digital signal processor, co-processor or other similar devices known to those having ordinary skill in the art, The applications described herein may be implemented as either software, firmware and/or hardware applications and may be implemented as a set of computer or machine-readable instructions stored in any type of non-transitory computer-readable or machine-readable storage medium or other storage device, Some non-limiting examples of non-transitory computer-readable mediums may be embodied using any currently known media such as magnetic or optical storage media including removable media such as floppy disks, compact discs, DVDs, BLU-RAY, flash memory, hard disk drives, etc. In addition, the storage device(s) as discussed herein comprise a combination of non-transitory, volatile or nonvolatile memory such as random access memory (RAM) or read only memory (ROM). One or more storage devices has stored thereon instructions that may be executed by the one or snore processors, such that the processor(s) implement the functionality described herein, in addition, or alternatively, some or all of the software. implemented functionality of the processor(s) may be implemented using firmware and/or hardware devices such as application specific integrated circuits (ASICs), programmable logic arrays, state machines, etc.

While some of the examples discussed herein are directed to drivers of vehicles transporting passengers, for example, in the context of a school bus transporting students, the principles disclosed herein may be applied in other applications, for example, guiding and tracking of garbage trucks that pick up trash, law enforcement vehicles delivering subpoenas, health care vehicles transporting medical professionals, etc.

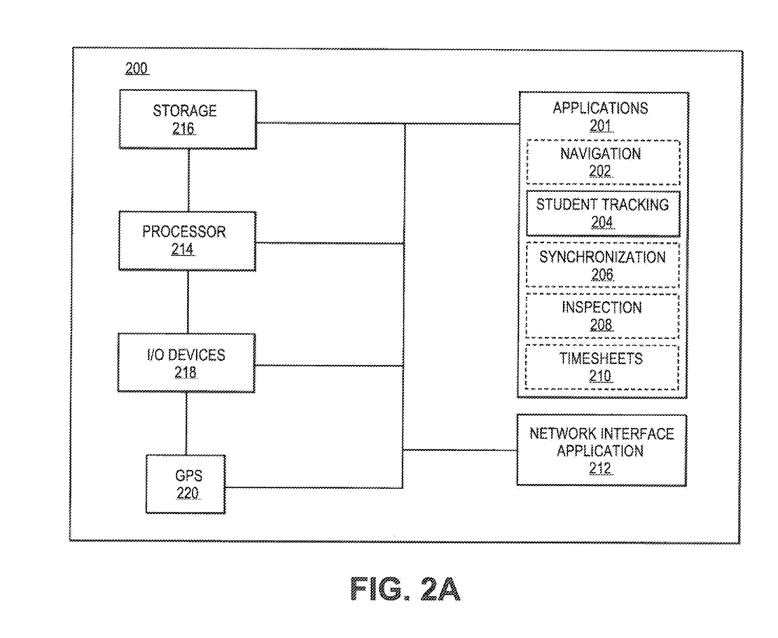

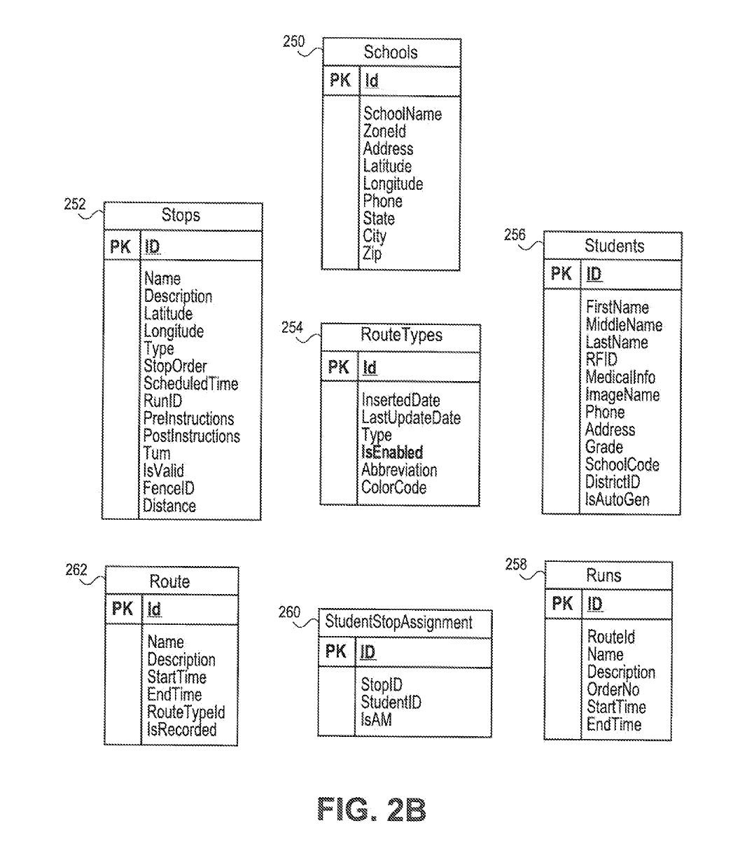

FIG. 2 depicts an example configuration of computing device 200. Device 200 may be implemented, for example, as computing device 118 depicted in FIG. 1. As shown in FIG. 2, device 200 may include applications 201. Applications 201 may include navigation 202, student tracking 204, synchronization 206, inspection 208, and timesheets 210. It may be appreciated that additional components may reside at device 200 in order to further perform the functionality as discussed herein. It may further be appreciated that while five components are depicted in applications 201 in FIG. 2, not all five components may be implemented in some examples consistent with the principles discussed herein. In some examples, only one, two, three or four components may be implemented within applications 201 in computing device 200.

Computing device 200 may further include network interface application 212 to facilitate network communication between device 200 and other devices within system environment 100.

Processor 214 may execute computer-readable instructions, stored in storage, to perform methods, processes, operations, steps or other functionality as described herein.

Storage 216 may store information that was transmitted from administrative device 102, for example, un and route information, student information, etc. Storage 216 may further store information computing device 200 generated and collected and that is to be transmitted to administrative device 102, as more fully discussed herein.

FIG. 2A depicts an example table structure that may be stored in storage 216. As shown in FIG. 2A, various tables may be stored, including schools 202, stops 204, RouteTypes 206, students 208, runs 210, student stop assignment 210 and route 212. The information included in these tables may be transmitted to computing device 118 from administrative device 102 during a daily update or a periodic update as more fully discussed below.

I/O devices 218 may include devices to facilitate information being entered into or sent out of computing device 200, for example, a display device, a keyboard, mouse, audio speaker, track pad, radio frequency reader, Bluetooth device, identification reader, for example a fingerprint reader, palm reader, bar code reader, etc.

Global positioning system (GPS) device 220 may be implemented as one or more GPS receivers, for example a cellular, or broadband GPS receiver, a National Marine Electronics Association (NMEA) GPS receiver, etc.

### Navigation

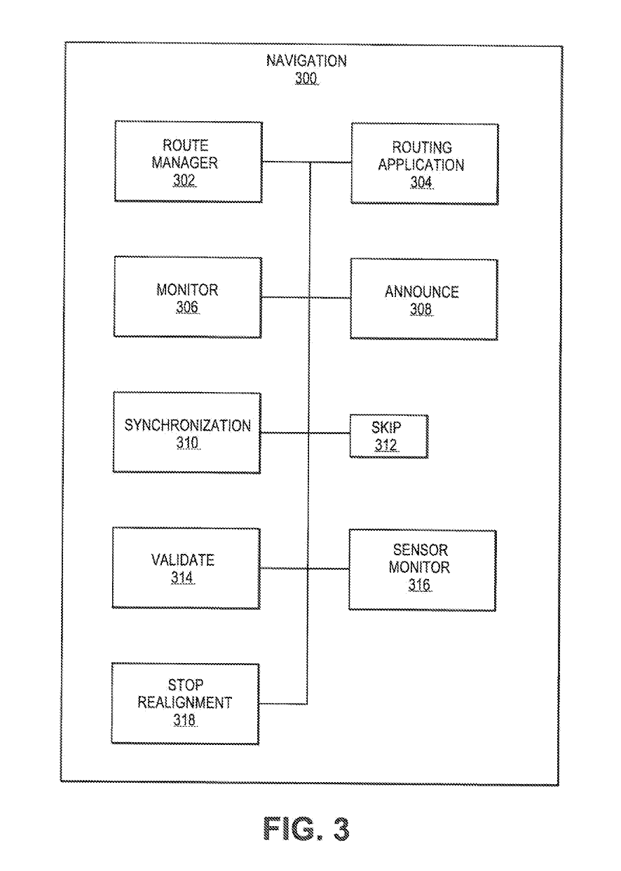

FIG. 3 depicts an example configuration of navigation application 300. Navigation application 300 may be implemented, for example, as navigation application 202 depicted in FIG. 2. As shown in FIG. 3, navigation application 300 may include route manager 302, routing application 304, monitor module 306, announce module 308, synchronization nodule 310, skip module 312, validate module 314, sensor monitor 316 and stop realignment 318. It may be appreciated that according to some examples, one or more of the modules depicted in FIG. 3 may not be present.

As noted above, information regarding runs and routes may be transmitted to computing device 118. This information may include one or more of multiple lat/long coordinates of waypoints and stop points that define one or more runs in one or more routes, lat/long coordinates of proximity locations of one or more of the waypoints and stop points, one or more announcements that may be associated with waypoints or stop points, directional, text-based instructions related to waypoints and stop points, etc.

Route manager 302 manages the information received in order to navigate the driver of the vehicle 120 along runs and routes. Specifically, route manager 302 selects a plurality of waypoints and a plurality of stop points, and sequentially submits each of the selected plurality of waypoints and stop points as destination points into a routing application 304. The plurality of waypoints and plurality of stop points define a path from a starting point of, for example, a run, to an ending point.

In order to achieve this functionality, the route manager 302 determines a run that is to be executed. This may be determined, for example, based on a login of a driver via a user interface at computing device 200, based on selection of a route and/or run via a user interface presented on a display device of computing device 118, etc. According to some examples, the login identification of the driver, together with other information, for example, a time of day, identifying information of a vehicle, etc., may determine run that, is to be executed. Route manager 302 may search storage 216 and determine and/or select all of the waypoints and stop points that may be associated with the run to be executed. These selected waypoints and stop points may be ordered from a starting point to an ending point. The waypoints and stop points may define every critical stop and turn on the path from the starting point to the ending point.

Route manager 302 interacts with routing application 304. Routing application 304 may be implemented as, for example, a geobase application, for example by Telogis, and mapping information, for example, provided by Navtec. It may be appreciated that other known routing applications and/or mapping applications may be utilized.

Routing application 304 may receive, in a sequential manner and in a serial manner, one at a time, lat/long coordinates as destination points from route manager 302. Routing application 304 may determine a route from a current location of the vehicle to the submitted let/long coordinate and display the route on a map. As the waypoints and stop points of all critical stops and turns on the path are provided by the route manager 302, the route manager 302 has a direct effect of the path that the vehicle takes from the starting point to the ending point. The routing application merely provides the map and a visual indicator on the map of the vehicle's current location and the next critical point in the path the vehicle is being directed to. The routing application 304, according to this example, has no effect on the path that is taken by the vehicle.

It may be appreciated that, according to some examples, routing application may have some effect on the path that is taken by the vehicle. For example, if some or all of the waypoints of the route or run are not provided by administrative device 102, or selected by the route manager 302, the stop points may be input into the routing application 304. Routing application 304 may select the path between the input stop points. The paths selected by the routing application 304 may be based on shortest distance, traffic, or other variables. The driver may be guided to the stop points based on the path determined by the routing application 304.

Monitor 306 monitors location information received from a global positioning system (GPS) receiver 220 and further monitors the waypoints and stop points that are submitted to routing application 304, Monitor 306 notifies route manager 302 when the waypoint or stop point submitted to routing application 304 has been reached. This may initiate, or trigger, the route manager 302 to select the next waypoint or stop point along the path and submit the selected next waypoint or stop point to the routing application as a destination point. Thus, any notification information received from the routing application regarding the destination can be ignored.

Monitor 306 may further monitor proximity coordinates of the waypoints and stop points that are submitted to the routing application 304. Based on information received from GPS receiver 220, monitor 306 may determine if a location from the GPS receiver matches a predetermined proximity location of the waypoint or stop point submitted to the routing application 304. If the vehicle is at the predetermined proximity location, as the location from the GPS receiver matches the predetermined proximity location of the waypoint or stop point, an instruction may be passed to the announce module 308 in order to determine if there is an announcement that is to be made.

If an instruction is received at the announce module 308, announce module 308 may check to see if there is any announcement associated with the predetermined proximity location or current waypoint or stop point submitted to the routing application 304. If there is an announcement associated therewith, the announce module 308 may announce the message, for example, via a speaker at the computing device 200, display the message on a display of computing device 200, or other provide an indication that there is information for the driver to know based on the upcoming waypoint or stop. The message may be related to routing, for example, may be a directional instruction, for example, turn left, turn right, proceed straight, make a U-turn, etc., or may be a message that is unrelated to directional information, for example, that a student boarding the vehicle may have a special need, such as assistance boarding the vehicle, that a student in a wheelchair is boarding the vehicle, etc.

Synchronization module 310 may synchronize instructions associated with each of the plurality of waypoints and each of the plurality of stop points with instructions received from the routing application. For example, there may be a discrepancy between the instructions received from administrative device 102 and instructions received from routing application 304. These discrepancies may occur, for example, when there is a different manner of representing street names, etc. For example, the term “parkway” may be represented as “parkway”, “PKE”, “PKY”, “PKWY”, or a state route number. The synchronization module may compare the instructions received from the administrative device 102 and the instructions received from the routing application 304 in order to confirm at the instructions received from the routing application relate to the submitted lat/long coordinates of the waypoint and/or stop point. if its determined that the instructions received from the routing application 304 represent the correct path to the lat/long coordinate submitted by the route manager 302, the map, together with an indication of the path to the destination point may be displayed on the display to the driver and the instruction received from the administrative device 102 may be presented on the display to the driver. However, if it is determined that the instructions received from the routing application 304 do not relate to the submitted lat/long coordinate, the map may not be displayed to the driver, while the text-based instruction from the administrative device 102 and associated with the waypoint or stop point may be displayed to the driver. This may ensure that the driver is following the path as determined by routing application 112 set by the school and not routing application 304.

Skip module 312 may enable a driver to skip a waypoint or a stop point. For example, the drive via the user interface at device 200, may determine a stop point may be skipped. For example, this may be because the driver received a notification that a student is not taking the vehicle to school. Instead of directing the vehicle to the stop, the driver may provide an indication, for example, via a field in the user interface, an actuatable button in the user interface, etc., to skip one or more stops. The skip module may communicate the skipped stop to the route manager 302.

According to some examples, when a stop is skipped, the route manager may still submit the lat/long coordinates of the skipped stop to the routing application 304. However, one or more announcements associated with that stop point may be suppressed and the driver may alternatively receive an indication not to stop at the stop point. In this example, the system may not reroute the vehicle along a different path in order to ensure the driver stays on schedule and arrives at the subsequent stop points at a scheduled time.

According to other examples, the skipped stop may be removed from the set of waypoints and stop points submitted to routing application 304. Route manager 302 may select the next waypoint or the next stop point along the path and submit the selected next waypoint or stop point to the routing application 304. The routing application 304 may then route the vehicle to the submitted waypoint or stop point. In this example, the routing application 304 may select a path to the submitted waypoint or stop point that is not influenced by route manager 302. Thus, routing application 304 may influence the path based on one or more variables including distance, traffic, etc.

Validate module 314 may validate the waypoints and stop points along a run based on information in the routing application 304. For example, when a waypoint or stop point is submitted into the routing application 304, route manager may receive information regarding the submitted waypoint or stop point, This information may be analyzed by the validate module 314 in order to determine if the routing application can identify the waypoint or stop point. For example, if the routing application returns two different destination points for the submitted waypoint or stop point, the validate module 314 may determine that the waypoint or stop point cannot be validated. This information may be displayed on a display of device 200 to inform the driver that the waypoint or stop point cannot be validated. Further, the map including the indication of the path the vehicle should take may not be displayed on the display. The user interface may display the instruction associated with the waypoint or stop point in order to direct the driver of the vehicle to the waypoint or stop point.

Stop realignment module 318 may monitor location information received from a GPS receiver when a sensor event is detected. A sensor event may be, for example, a door open event indicating the door of the vehicle has been opened or closed, turning on or off amber flashing lights, turning on or off red flashing lights, turning on or off the ignition of the vehicle, etc The stop realignment module 318 may further determine if the sensor event occurs at the same location (lat/long) of the stop point. If the sensor vent occurs at a location that is different from the expected waypoint or stop point, the stop realignment module 318 may store information associated with the sensor event, for example, one or more of stop point identifying information, identification information of sensor event, the location of where the sensor event occurred, the time the sensor event occurred, etc. The information may be used within system environment 100 in order to determine if the location of the stop point should be changed based on stored sensor information. For example, a threshold may be set such that if the sensor event occurs x number f times at the same location that is different from the location of the stop point, an alert may be generated and transmitted to administrative device to approve the change of the lat/long coordinates of the stop point.

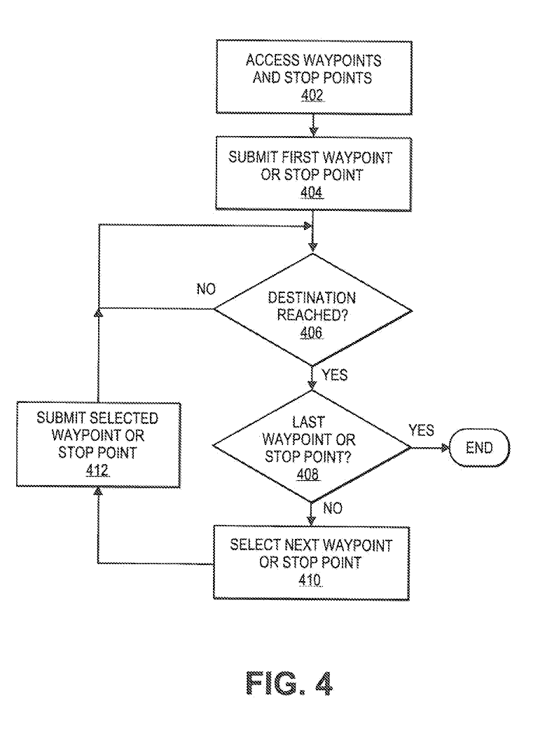

FIG. 4 depicts an example flow diagram of a process for guiding a vehicle along a path including a plurality of waypoint and stop points. FIG. 4 may be implemented at least in part, for example, by route manager 302, routing application 304 and monitor module 306. As shown in FIG. 4, a plurality of waypoints and stop points are accessed at 402. The plurality of waypoints and stop points are selected for a run that has been identified, for example, by a driver through a user interface, based on a vehicle number and a time, based on driver identification information, etc. the plurality of waypoints and stop points may ordered in an order such that they define a path from a starting point to an ending point.

The first waypoint or stop point is submitted 404. The first waypoint or stop point may be submitted by the route manager 302 to the routing application 304 as a destination point. A determination is made whether the destination has been reached 406. The determination may be made by monitor module 306 based on information received from GPS 220. If the destination has not been reached (406, NO) processing proceeds to 406 until the destination is reached. When the destination has been reached (406, YES), processing proceeds to 408 where a determination is made whether' the last waypoint or stop point was submitted 408. If the last waypoint or stop point was submitted (408, YES), the guiding ends. If the last waypoint or stop point was not submitted (408, NO), processing proceeds to 410 where the next waypoint or stop point along the path is selected. The selected next waypoint or stop point is submitted to the routing application 304 at 412 and processing proceeds to block 406 to determine if the destination of the submitted waypoint or stop point has been reached. The check at block 406 is made until the destination has been reached and processing proceeds to block 408 to determine if the submitted waypoint or stop point is the last waypoint or stop point along the path. Processing proceeds in this fashion until the last waypoint or stop point is reached.

It may be appreciated that according to some examples, a map may be displayed including an indication of a path from a current location of the vehicle to the destination point, for example the submitted waypoint or stop point. This may provide guidance information to the driver.

According to some examples, a determination may be made as to whether there is an announcement associated with the submitted waypoint or stop point. If there is an announcement associated with the waypoint or stop point, the announce module 308 may execute the announcement, for example, via a speaker at computing device 200, displaying the announcement on the display of computing device 200, or provide an indication that there is an announcement.

According to some examples, an indicating may be received, for example, via a user interface, to skip one or more of the plurality of stop points. When this indication to skip a stop point is received, the stop point may be removed from the list of stop points to be submitted to the routing application 304 by route manger 302.

According to other examples, the skipped stop, may be submitted to the routing application 304, and the driver of the vehicle guided to the stop point, however, one or more announcements associated with the stop point may be suppressed and not announced. The driver may be instructed not to stop the vehicle at the stop point. According to some examples routing application 304 may reroute the path to a next sequentially submitted waypoint or stop point.

According to some examples, information may be stored when waypoints and/or stop points are reached by the vehicle, for example, a time may be stored indicating when the vehicle reaches each of the destination points submitted to routing algorithm 304, a location of the vehicle, a list of students on board the vehicle, the status of one or more sensors, etc.

According to some examples, validate module 314 may determine whether the submitted waypoints and/or stop points are validated and provide an indication to be displayed on the display of device 200 indicating whether the waypoint or stop point is validated.

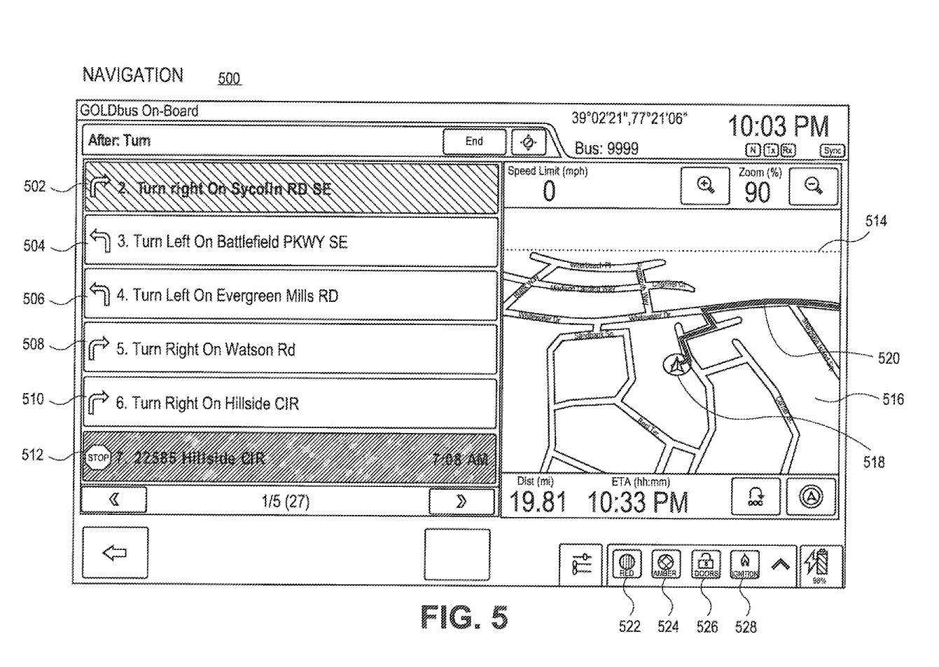

FIG. 5 depicts an example screen display 500 that may be displayed on a display at computing device 200. As shown in FIG. 5, display 500 includes pane 502 listing text-based instructions presented to a driver to guide the driver along a path. Instructions 504, 506, 508 and 510 represent instructions associated with waypoints along the path. Instruction 512 represents instructions associated with a stop point. Display 500 further includes pane 514 depicting a map 516, an indicator 518 depicting a current location of the vehicle, and an indication 520 of a path the vehicle should take.

Additional components of screen display 500 are depicted in FIG. 5, for example, indications of the status of sensors monitored by sensor monitor 316 including an indication 522 of whether the red lights are flashing, an indication 524 of whether the amber lights are flashing, an indication 526 of whether a front door to the vehicle is open, and an indication 528 of whether the ignition was activated and the vehicle is running. It may be appreciated that additional indicators representing the status of sensors may be provided and monitored by sensor monitor 306, for example, whether a back door, driver door, wheelchair access door, or any other door is open, engine performance including rate of acceleration, speed, or any other on-board diagnostics, etc.

It may be appreciated that, according to some examples discussed herein, information related to the performance of the vehicle as it is, guided along the path may be determined and stored. For example, for each waypoint and stop point, information may be captured and stored, for example, the time the vehicle arrived and/or left each waypoint and stop point, sensor status information for sensor events that occur during the run including the time the sensor event occurred, driver identification information, route identification information, run identification information, vehicle identification information, vehicle diagnostic information as determined by an on board diagnostic system (not shown), any alerts that may have been manually entered via the user interface by the driver, etc. One or more of this information may be transmitted to an administrative device as more fully discussed below.

### Student Tracking

Student tracking application 204 may manage a status of a plurality of sets of objects, where each of the objects represents a person, or student, scheduled to board a vehicle. The status indicates whether the person boarded the vehicle, and, if the person boarded the vehicle, where the person boarded the vehicle. Student tracking application 204 may further facilitate providing an interface to display a set of objects based on a location, or stop point, of the vehicle, The user interface may be configured to receive an indication when the person boards the vehicle.

According to some examples student tracking may be implemented via receipt of student information via the user interface on computing device 118. According to some examples, student tracking may be implemented via an identification reading device. According to, some examples, student tracking may be implemented via a combination of receipt of student information via a user interface on computing device 118 and via an identification reader device.

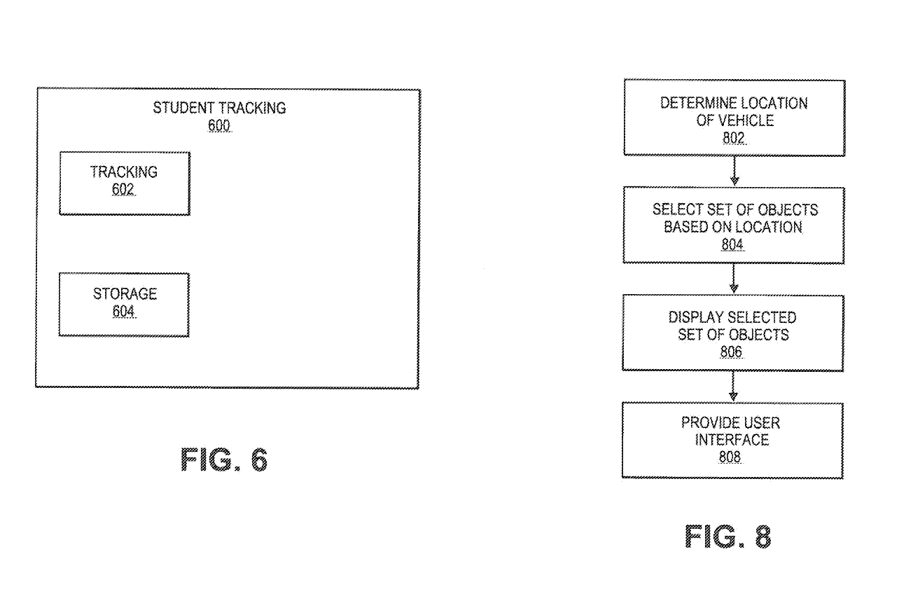

FIG. 6 depicts an example block diagram of the components included in student tracking application 600. Student tracking 600 may be implemented as, for example, student tracking application 204 in FIG. 2. As shown in FIG. 6, student tracking application 600 includes tracking module 602 and storage 604.

Storage 604 stores a plurality of sets of objects, where each of the objects represents a person and each of the objects is associated with a location. For example, storage 604 may store student information received from administrative device 102. Student information may include one or more of a student's name, address, emergency contact information, location information, for example, lat/long of the stop the student is to board the vehicle, the lat/long of where the student is to get off the vehicle, an image of the student, medication the student may be taking, special instructions associated with the student, etc.

Tracking module 602 may track whether each of the objects boards a vehicle and further may track whether each of the objects boards a vehicle at the location associated with each of the objects.

Tracking application 600 may provide information to a user interface for display on a display device. The information may include the set of objects associated with the location of a vehicle at a stop point. For example, tracking application 600 may provide student information, for example, name, picture, etc., to the user interface for display when the vehicle is located at the location the set of students is scheduled to board the vehicle.

The user interface may receive an indication that one or more of the objects in the set of objects has boarded the vehicle. In other words, when the student boards the vehicle, the system may receive an indication, for example, through the user interface, via an identification reader, etc., that the student has boarded the vehicle. The indications received via the user interface may be monitored by tracking module 602, and tracking module 602 may store the indications, and update the tracking information accordingly, for example, by updating a status associated with the student indicating the student boarded the vehicle and updating a display.

According to some examples, an indication may be received via an identification reader, for example, an radio frequency (RF) scanner scanning an RF tag including identifying information of a student, a fingerprint reader for reading a fingerprint of a student, a palm reader for reading a palm of a student, Bluetooth device for receiving identifying information from a device of a student, or any other means by which identifying information of a student may be received,

In some examples, the tracking module 602 may determine a subset of objects that did not board the vehicle. For example, for those students that did not board the vehicle, where computing device 118 did not receive an indication associated therewith that the student boarded the vehicle, the tracking module may transmit the subset of objects to administrative device 102. This may alert an administrator at the administrative device that students that were scheduled to board the vehicle did not board the vehicle.

In some examples, input may be received, for example, via the user interface, via an identification reader, etc., identifying a person that boarded the vehicle but was not included in the set of students scheduled to board the vehicle, for example, at that location. The tracking module 602 may determine whether the person that was not included in the set of students scheduled to board, the vehicle is included in the sets of students scheduled to board the vehicle at any of the stop points long the vehicle's current run, or, in other examples, any of the vehicles runs. If the person was not scheduled to board the vehicle at any of the stop points along the vehicle's run, tracking module 602 may initiate transmission of an alert to administrative device. This may notify the school administration that the vehicle is bringing a student to the school that was not scheduled to board the vehicle.

According to some examples, if the tracking module 602. determined that the person was scheduled to board the vehicle at a different stop point along the vehicle's run, the tracking module 602 may store an indication including the identifying information of the student and the location at which the student boarded the vehicle. This information may be included in the information that is transmitted back to administrative device 102 for analysis.

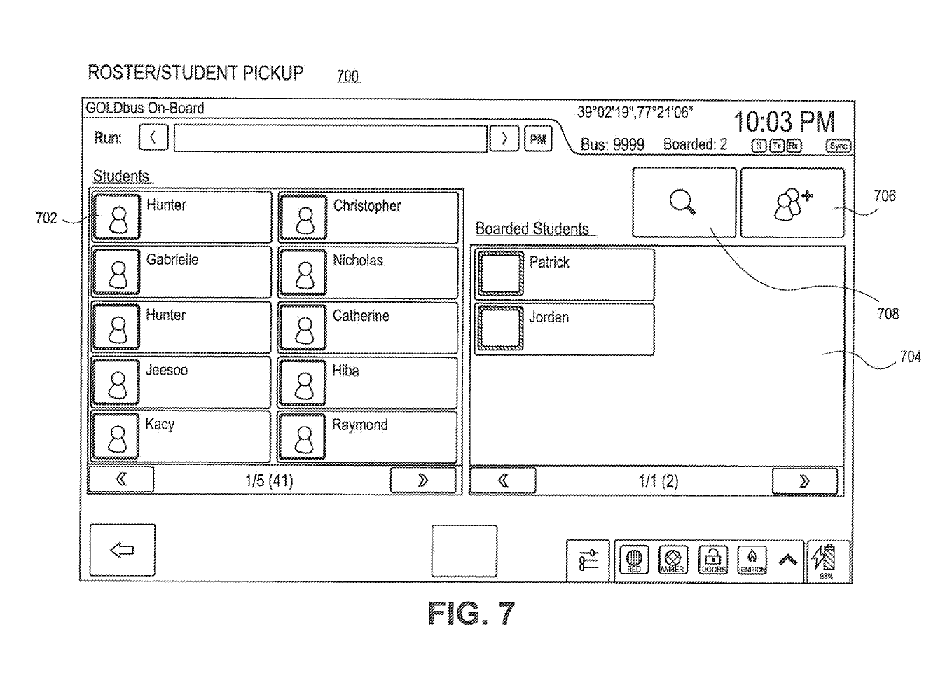

FIG. 7 depicts an example screen display 700 of a screen to be displayed on a display device when the vehicle is approaching or is at a stop point. As shown in FIG. 7, screen display 700 includes pane 702. Pare 702 depicts students that are to be picked up at the stop point. Screen display 700 further includes pane 704, Pane 704 includes the students that have boarded the vehicle. A student may move from pane 702 to pane 704 when an indication is received that the student boarded the vehicle.

Button 706 is an actuatable button that may facilitate entry of student information for a student that boarded the vehicle, but is not scheduled to board the vehicle at the stop point where the vehicle is located. Search button 708 is an actatable button that may facilitate searching the plurality of sets of students for the run to see if the student was scheduled to board the vehicle during the current run, but is boarding at an improper stop point.

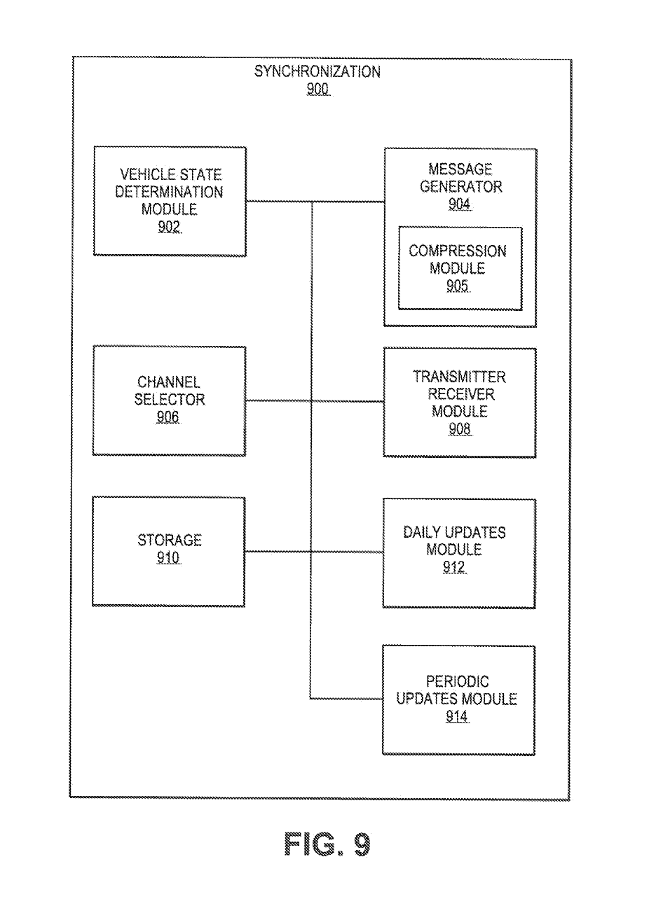

FIG. 8 depicts a flow diagram of a process for selecting and displaying a set of objects associated with a location of a vehicle. The process depicted in FIG. 8 may be performed, for example, at least in part, by student tracking application 600. As shown in FIG. 8, the location of a vehicle may be determined 802. The location of the vehicle may be determined when the vehicle is at a stop point.

A set of objects may be selected based on the determined location of the vehicle 804. For example, tracking module 602 may access student information stored in storage 604 and select the student information associated with stop point at the vehicle's determined location. The selected objects may be displayed on a display 806. A user interface may be provided 808 that may facilitate receiving an indication when a student boards the vehicle. The indication may be received as input via the user interface, or may be received via an identification reader.

According to some examples, tracking module 602 may determine a subset of objects representing people that did not board the vehicle, but were scheduled to board the vehicle. Tracking module may transmit the subset of objects to administrative device 102.

According to some examples, the user interface may provide means for receiving student information associated with a student that is not scheduled to board the vehicle at any stop point along the run. An alert may be generated and transmitted to administrative device 102 with the student information.

According to some examples the user interface may provide means for receiving student information associated with a student that is boarding the vehicle at an improper stop point. An indication may be stored indicating that the person boarded the vehicle at an improper stop point. In addition, the location where the student boarded maybe stored.

### Synchronization

Synchronization application 206 may, according to some examples, provide the ability to transmit data from computing device 118 to administrative device 102 based on one or more predetermined rules. This may result in regulating the timing and/or the amount of data transferred real-time from the vehicle to the administrative server, thereby ensuring compliance with pre-set data network usage limits. According to some examples, synchronization application 206 may facilitate receipt of information from administrative device 102.

According to some examples, synchronization application 206 may automatically convert from general pack radio service (GPRS) communication to Wi-Fi communication based on geo-fencing and/or other predetermined rules enabling cost efficient communication and increased data transfer rates.

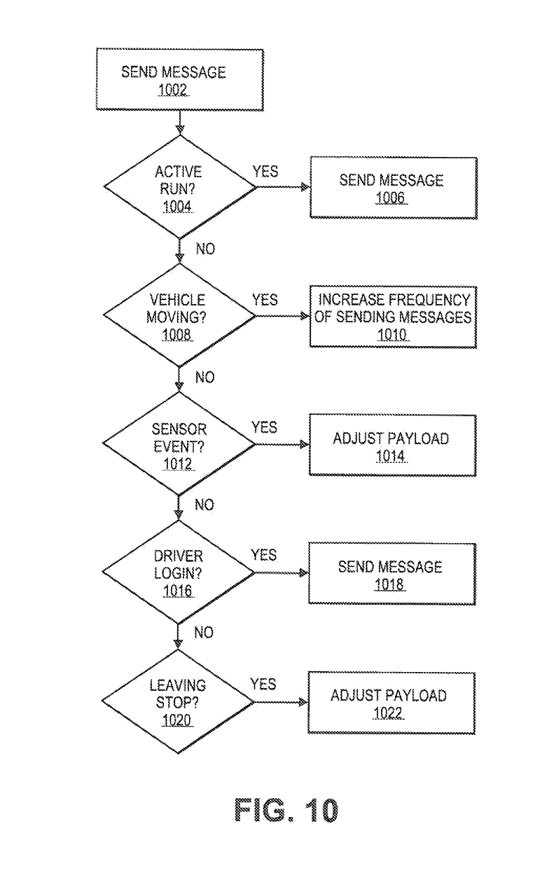

FIG. 9 depicts a block diagram of components included in synchronization application 900. Synchronization application may be implemented by, for example, synchronization application 206. As shown in FIG. 9, synchronization application 900 includes vehicle state determination module 902, message generator 904, channel selector 906, transmitter/receiver module 908, storage 910, daily updates module 912 arid periodic updates 914.

The synchronization application 900 may facilitate receipt of updates and transmission of information captured and stored during one or more runs, routes, etc. of the vehicle.

Vehicle state determination module 902 may determine a state of one or more sensors in the vehicle, and/or the state of one or more systems in the vehicle. For example, vehicle state determination module may determine a state of amber lights (flashing or not), red lights (flashing or not), door (open or closed), ignition (on or off), speed of the vehicle (mph), rate of acceleration, other on-board diagnostics, etc.

Message generator 904 may generate a message including information obtained during one or more runs. The message generator 904 may select information to include in the message based on predetermined rules. The predetermined rules may relate to, for example, vehicle state information. For example, message generator may generate messages having information related to one or more of student tracking information, (student identifying information for students that have boarded the vehicle), location tracking information (a current location of the vehicle, pre-trip inspection data, post-trip inspection data, user login information (driver identifying information), etc. Frequency of the message, and the type of information included in the message may vary based on predetermined rules, for example, if the vehicle is in an active run, if the vehicle is moving, if a sensor is activated, if a driver has logged in, if the vehicle is traveling over a predetermined threshold speed, if the vehicle is accelerating at a rate that exceeds a predetermined threshold, etc.

The message generator 904 may transmit generated messages at a rate based on predetermined rules, for example, if the vehicle is in an active run, if the vehicle is moving, if a sensor is activated, if a driver has logged in, if the vehicle is traveling over a predetermined threshold speed, if the vehicle is accelerating at a rate that exceeds a predetermined threshold, etc.

Message generator 904 may include compression module 905 to compress the data in order to minimize data transfer costs.

Compression module 905 may utilize a variable payload algorithm that varies the payload. For example, the compression module 905 may parse a message generated by the message generator 904 to identify an optimal payload size for example, between 2 to 6 bits. This value is passed in the header of the message as a “compression type” variable. When the message is received at the administrative device, the compression type variable in the header is used to assemble the original message. A byte (8 bits) type format is used, for easy manipulation using existing programming data structures.

According to some examples, the following process may compress a message from the computing device 118 to administrative device 102, where the message includes information related to the vehicle being guided along a path as discussed here. In executing the process, the compression module 905 may generate a message incorporating location information related to a vehicle being guided along a path. The compression module 905 may further parse the generated message to identify one or more repeats of values in the message. The number of repeats identified may be counted. The compression module 905 may remove all but one of the repeats and insert in a header of the message, for example, as a compression type, the number of repeats and the payload. In this example, there may be a maximum number of bits to represent the payload and the number of repeats, for example, one byte. Thus, if the payload size is large then the repeat value is small and visa versa.

In the case where the number of repeats and the payload may exceed the maximum number of bits, one or more additional bytes may be used to compress the payload data.

Channel selector 906 may select a channel of communication, from a plurality of available channels, to transmit messages generated by message generator 904. The plurality of channels may include Wi-Fi over a wireless network (where the vehicle is in or near an area of the school, the yard where the vehicles are stored, etc.), and GPRS or other cellular communication channels (when the vehicle is not near the area of the school or the yard where the vehicles are stored).

According to some examples, channel sector 906 may select an emergency channel, such as the 911 emergency channel, to transmit an alert in the case of an am emergency. The alert may be transmitted in the form of a prerecorded message in an audio file, SMS message, etc. to administrative device 102. This may be implemented in the case where the data channel is not available.

Transmitter/receiver module 908 to facilitate transmission of generated messages to administrative device 102 and receipt of messages from administrative device 102.

Storage 910 may store information captured by computing device 118 including event information, vehicle location information, sensor event information, student tracking information, driver log-in information, driver log-out information, pre-trip inspection information, post-trip inspection information, etc. Storage 910 may further store information received from administrative device 102 including student roster information, waypoint and stop point information in the form of lat/long coordinates, announcements associated with the waypoints and stop points, route information, run information, pre-trip inspection data, post-trip inspection data, etc. It may be appreciated that storage 910 may be implemented as a separate storage on computing device 118 or may be implemented as part of storage 216.

Daily updates module 912 facilitates receipt and processing of daily updates received from administrative device 102. Daily updates may include information relating to routes, runs, waypoints and stop points, students, etc.

Periodic updates module 914 may facilitate receipt and processing of periodic updates received from administrative device 102. Periodic updates may include information associated with pre-trip inspections, drivers, etc.

According to some examples, the synchronization application has a limit on the costs associated with data transmission to and from device 118. Thus, the synchronization module may reduce a frequency in which messages are transmitted when it is anticipated that there is no noteworthy activity, and increased the frequency in which messages are transmitted when it is anticipated that there is noteworthy activity.

FIG. 10 depicts an example diagram of decision points that may affect a frequency and/or payload of messages to be sent from computing device 118 to administrative device 102.

As shown in FIG. 10, synchronization application 900 may determine that messages should be transmitted to administrative device 102. Thus, at 1002, synchronization application 900 starts to send messages at a default frequency, considers various decision points in parallel and sends messages and/or adjusts the frequency and/or payload based on the various decision points.

At 1004, a decision may be made whether an active run is occurring,. This may be based on the current time, and whether a run should be occurring based on the current time. If there is an active run, messages may be sent at a predetermined interval at 1006.

At 1008, a decision may be made whether the vehicle is moving. If the vehicle is moving, the frequency of transmission of messages may be increased at 1010. According to some examples, a further decision may be made whether the vehicle is moving faster than a predetermined speed. If the vehicle is moving faster than a predetermined speed, the frequency of transmission of messages may be further increased. If the vehicle has stopped moving, or if the vehicle has stopped moving faster than a predetermined speed, the frequency in which messages are being transmitted may be reduced to a default value.

At 1012 a sensor event may be detected. For example, if the sensor event is an amber lights on event, a payload of ,a message may be adjusted to include a roster of students on board the vehicle 1014.

At 1016, a decision may be made that the driver has logged into the system. If the driver logs into the system then a message may be sent at 1018.

At 1020, a decision r may be made whether the vehicle is leaving a stop point. If the vehicle is leaving a stop point, the payload of the message may be adjusted to remove the roster of students from the message in order to save on data transmission usage.

According to some examples, the packet size may be adjusted based on a state of the vehicle including one or more of the door sensor, amber lights sensor, red lights sensor, etc.

According to some examples discussed herein h messaged may be encrypted for security using an encryption algorithm.

According to some examples, the daily update module 912 and the periodic update module 914 may receive only the differential information updated from the most recent update transmission. In other words, a copy of the daily and periodic update data may be stored at administrative device. The administrative device may compare the copy of the data on the computing device 118 with the updated data and only transmit the updated data to computing device 118.

In addition, bandwidth monitoring may occur. For example synchronization application 900 may check to determine the available bandwidth for the rest of, for example, the month. This may be checked by the computing device 118 communicating with the administrative device 102, or cellular provider device 126. Further, a calculation may be made to determine how many additional messages may be needed to be sent based on the number of messages already sent for the same billing cycle, based on the messages sent from a previous billing cycle, etc. the frequency of the messages may be further adjusted in order to ensure that the data usage does not exceed the computing device's allowed usage. The adjustment may be made by prioritizing messages to be sent. For example, messages to be sent based on a sensor event may take priority over a periodic message. Further adjustment may be made by reducing the default frequency in which messages are being sent.

It may be appreciated that according to some examples, different events, for example telemetric events relating to engine performance, or I/O sensors that monitor, door lights and ignition states may affect the frequency in which messages are being sent.

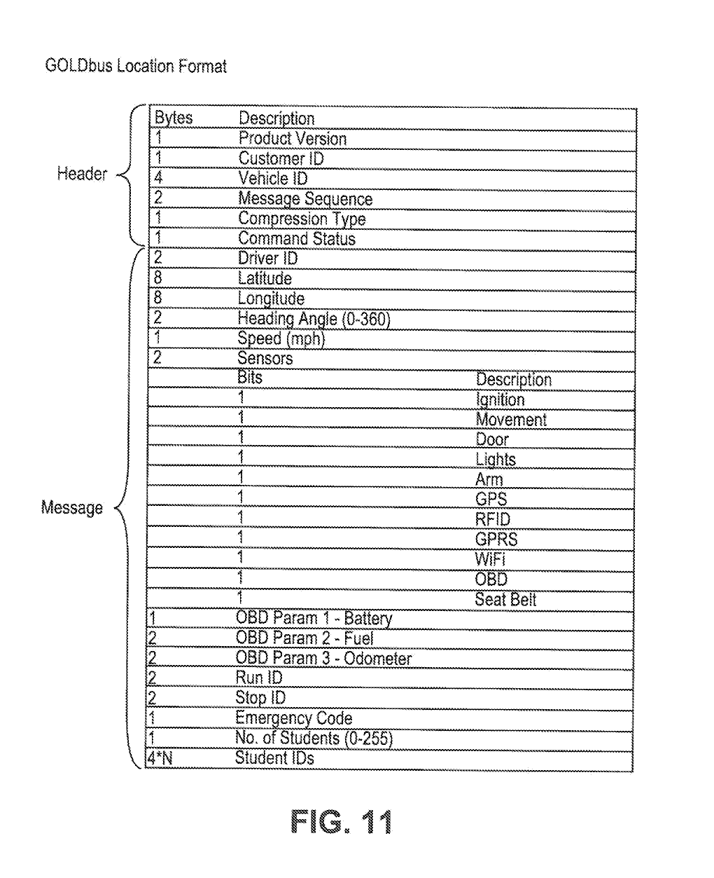

FIG. 11 depicts an example format of a message that play be transmitted from computing device 118 to administrative device 102. It may be appreciated that, as discussed above, the payload of the message may be adjusted based on the decisions noted with respect to FIG. 10.

### Hub 108

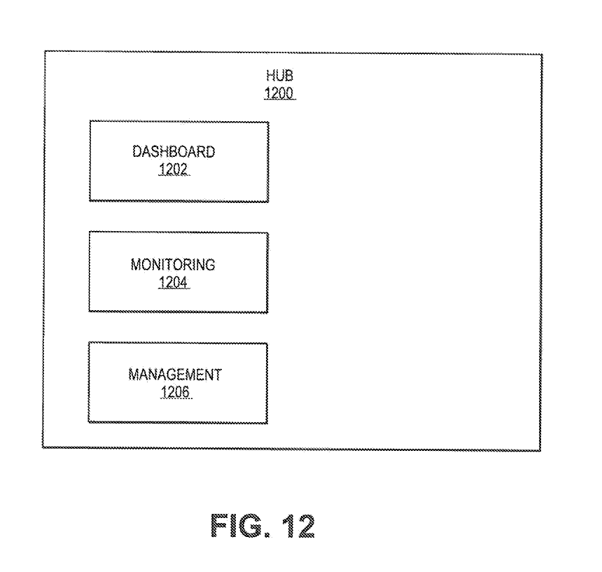

FIG. 12 depicts an example block diagram of some of the components included in hub 1200. Hub 1200 may be implemented as, for example, hub 108. As shown in FIG. 12, hub 1200 includes dashboard 1202, monitoring 1204 and management 1206.

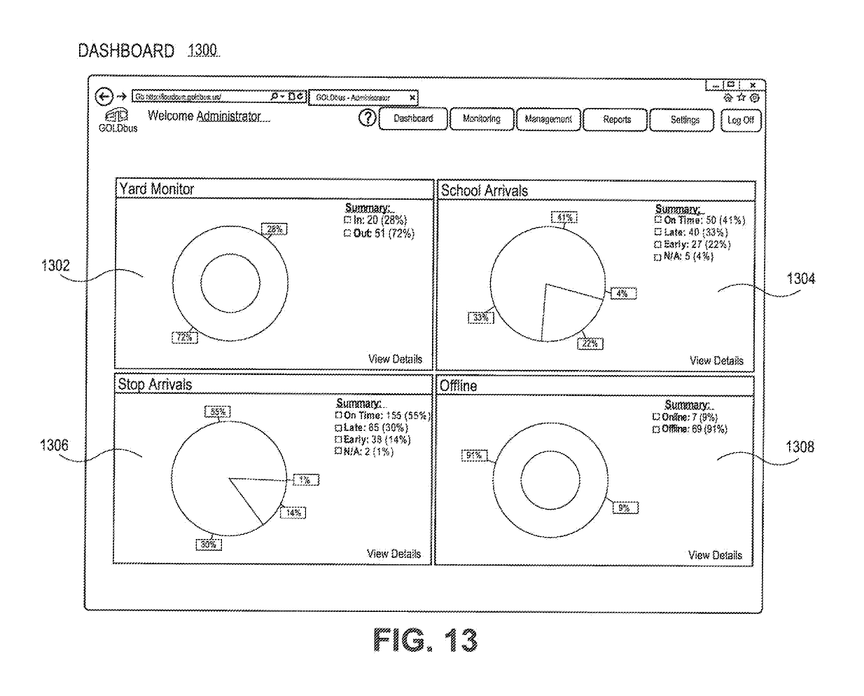

Dashboard 1202 may facilitate real-time monitoring of one or more metrics based on information that is transmitted from computing device 118. FIG. 13 depicts an example screen display of a dashboard displayed on a display device at administrative device 102. As shown in FIG. 13, screen display 1300 is depicted. Screen display 1300 includes a dashboard of a yard monitor 1302. Yard monitor may show, in real time, the percentage of vehicles that are in the yard and outside the yard. This may be calculated from the data that is being transmitted from computing devices in all of the vehicles in the system. As the computing devices that are in operation in the vehicles are transmitting location information at a frequency in real-time, to the administrative server 102, the dashboard module 1202 may analyze the received information in order to determine the location of each of the vehicles in the fleet. Thus, administrative server may calculate the percentage of vehicles in the yard and outside the yard and present the information in the pie chart depicted in FIG. 13.

Screen display 1300 may further display real time information related to school arrivals 1304. Again, as each of the computing devices in the vehicles in the system are transmitting location information in real time at a frequency to administrative server 102, dashboard module 1202 may access this information and analyzing this information to determine the number of, and/or percentages of, vehicles that are on time, late or early to arrive at the school, or not applicable as the vehicle may not have been in use.

Screen display 1300 may further display real time information related to stop arrivals 1306. Utilizing the location information transmitted from the computing devices in the vehicles, dashboard module 1202 may access and analyze this information in order to determine the number of, and percentages of, vehicles that are on time, late or early to their stops, or not applicable as the vehicle may not have been in use.

Screen display 1300 may further display real time information related to computing devices that are off-line and on-line. Utilizing the location information transmitted from the computing devices in the vehicles, the dashboard module 1202 may access the information and determine the number of, and/or the percentage of devices that are on-line and off-line.

It may be appreciated that additional dashboards may be provided based on any of the location information that is transmitted from the computing devices to the administrative server 102.

Monitoring module 1204 may provide active monitoring of student on-boarding and off-boarding based on the location information that is transmitted from computing devices in the vehicles to the administrative server. This real-time monitoring may facilitate communication between the driver of the vehicle and an administrator, parents, and/or other authorized users when student boarding or off-boarding is not in accordance with the route/run information.

In addition, monitoring module 1204 may provide real-time parent notification of their child's transportation status, including one or more of mapping or report based on status of boarding or de-boarding of the vehicle, participation in field trips, school vehicle breakdowns, anticipated arrival time to assigned stop points, travel delays, status with regard to geo-fenced off areas, etc.

According to some examples, predetermined rules may be defined such that as the location information is received at administrative device 102, monitoring module 1204 may analyze the location information and apply the predetermined rules. For example, if location information is received and there is no driver identification information, this may indicate that the driver of the vehicle did not properly log into computing device 118.

As another example, a geo-fence may be defined as a series of lat/long coordinates that define an area. One or more predetermined rules may be assigned to the geo-fence. When location information is received from the computing device 118, at administrative device 102, monitoring module 1204 may analyze the location information to determine if the predetermined rules are being followed For example, if a geo-fence has a predetermined rule where no vehicles are allowed within the area defined by the geo-fence, if the monitoring module 1204 determines that the vehicle went into the geo-fence area, an alert may be generated and, for example, sent to the driver of the vehicle to leave the geo-fence area.

As another example, a predetermined rule that applies to passengers may be assigned to a geo-fence. For example, a predetermined rule relating to whether a passenger boards or de-boards the vehicle may be assigned to a geo-fence such that an alert may be generated. As an example, when a particular passenger de-boards within the geo-fence, an alert may be generated and transmitted to, a driver of the vehicle, a parent of the passenger, an administrator, etc.

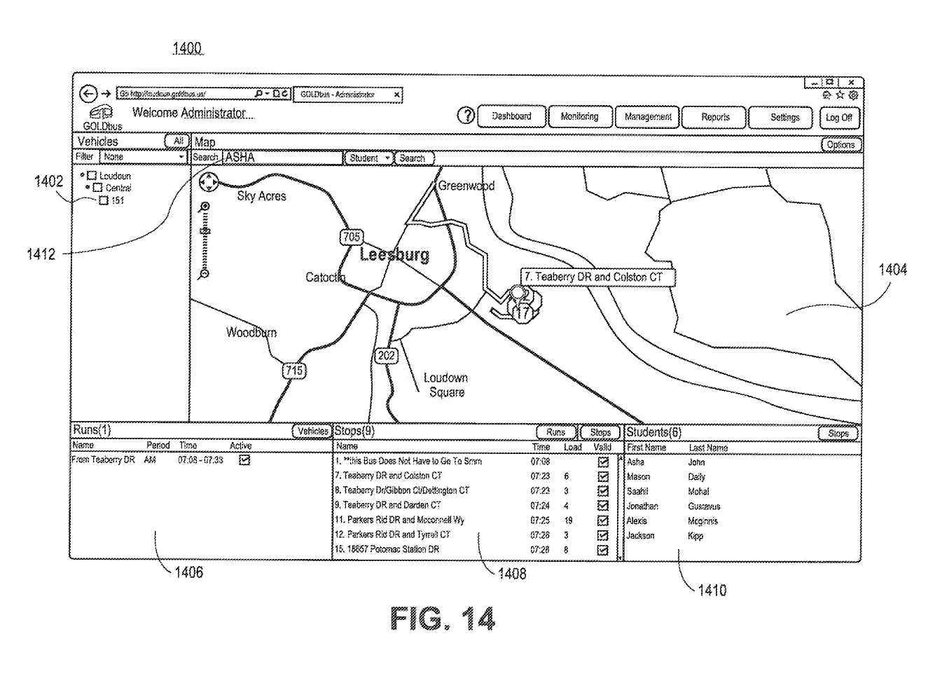

FIG. 14 depicts an example screen display of a user interface 1400 that may be displayed on a display device at, for example, administrative device 102. User interface 1400 may be utilized to monitor one or more vehicles in a fleet in real-time. As shown in FIG. 14, real time monitoring of vehicle number 151 is displayed at 1402. A map 1404 is displayed showing the current location of the vehicle and the stop points along the run of the vehicle. Pane 1406 depicts the run the vehicle is currently executing. Pane 1408 depicts the stop points the vehicle has made, the time the vehicle arrived at the stop points, and how many passengers the vehicle picked up at the stop points. Further, an indication is provided as to whether the stop point is a valid stop point, as discussed above. Pane 1410 provides a list of the passengers that boarded the vehicle at the selected stop. As depicted in pane 1410, six students are listed that were picked up at Teaberry DR and Colston CT at 07:23. Interface 1400 further provides a search function 1412 that enable a user to search for a particular student. As shown in 1412, ASHA, a student, is the search term. Upon selecting the “search” actuatable button, the search results may be listed in pane 1410. Further information associated with ASHA may further be retrieved including the stop point and time that ASHA boarded the vehicle, and the run that the vehicle was executing when ASHA boarded the vehicle. Thus, a reverse search may be performed in order to quickly locate information associated with a student in system environment 100.

Management module 1206 may facilitate management of information with system environment 100. For example information related to the fleet may be managed via a user interface provided on a display device at administrative device 102. For example, vehicles may be added or removed from the fleet, assigned identifying information including one or more of a vehicle number vehicle, identification number (VIN), license plate number, make, model and year of the vehicle, etc., added or removed from a group of vehicles, etc. According to some examples, pre-trip inspections and/or post trip inspections may be generated and assigned to one or more vehicles in a group or in a fleet.

According to some examples, time sheets may be managed. For example, job types may be entered and information associated with the job types may be entered and managed. Information associated with job types may include a job title, a tax rate, a pay rate, etc.

According to some examples, when a driver logs into computing device 118, the driver may identify what job type the driver is starting, for example, “driver”. The job type “driver” may have associated therewith certain attributes as defined by the management module, including a time slot, rate of pay, etc. When the driver completes the shift, the driver may log out of the “driver” job type. if the driver is starting a different job type, for example, maintenance worker that maintains the vehicle, the now former “driver” may log into computing device as a “maintenance worker”, effectively clocking into the shift. All of the attributes associated with the job type “maintenance worker”, including rate of pay, etc., may apply to the now “maintenance worker” and the maintenance worker may be compensated accordingly.

According to some examples, absence types may be managed. Absence types may include a name of an absence, whether the absence type affects a pay rate, etc. Absence reasons may further be managed, and may include reasons for absences, whether the reason affects a pay rate, etc.

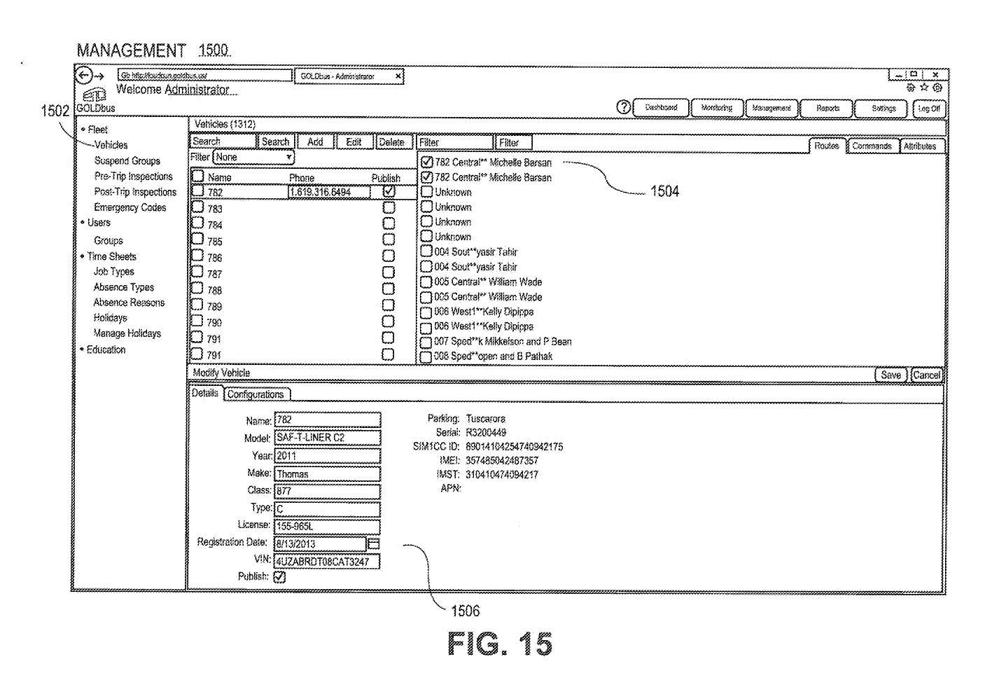

FIG. 15 depicts an example screen display of a user interface 1500 that may be displayed on a screen and utilized to manage information associated with a fleet, a user, time sheets, etc. As can be seen in FIG. 15, the user interface for managing vehicles in a fleet is selected at 1502. At 1504, vehicle number 782 is selected. In pane 1506, information may be received via the user interface to modify details or configurations of vehicle number 782.

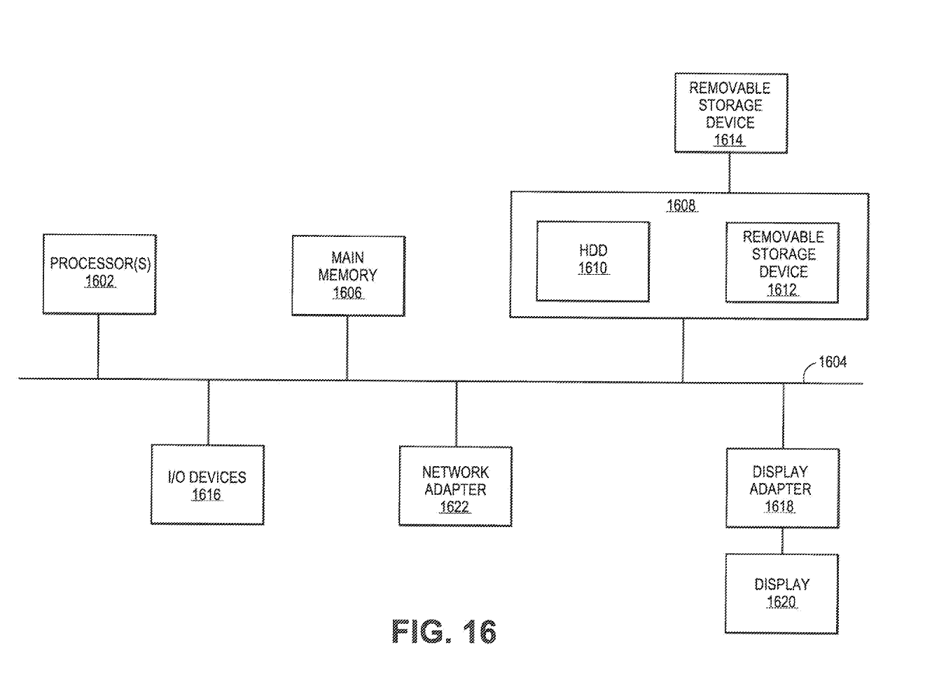

FIG. 16 illustrates a block diagram of a computing apparatus 1600, such as the device 118 or 102 depicted in FIG. 2, according to an example. In this respect, the computing apparatus 1600 may be used as a platform for executing one or more of the functions described hereinabove.

The computing apparatus 1600 includes one or more processors 1602, such as the processor(s) 214. The processor(s) 1602 may be used to execute some or all of the steps, operations, or functions described in the methods and processes depicted in FIGS. 4, 8 and 10 and further discussed herein. Commands and data from the processor(s) 1602 are communicated over a communication bus 1604. The computing apparatus 1600 also includes a main memory 1606, such as a random access memory (RAM), where the program code for the processor(s) 1602, may be executed during runtime, and a secondary memory 1608. The secondary memory 1608 may include, for example, one or more hard disk drives 1610 and/or a removable storage drive 1612, representing a floppy diskette drive, a magnetic tape drive, a compact disk drive, etc., where a copy of the program code for the methods depicted in FIGS. 4, 8 and 10 and other methods described herein may be stored.

The removable storage drive 1610 may read from and/or write to a removable storage unit 1614 in a well-known manner. Input and output devices 1616 may include a keyboard, a mouse, a display, etc. A display adaptor 1618 may interface with the communication bus 1604 and the display 1620 and may receive display data from the processor(s) 1602 and convert the display data into display commands for the display 1620. In addition, the processor(s) 1602 may communicate over a network, for instance, network 122, the Internet, LAN, etc., through a network adaptor 1622.

What claimed is:

1. A computer-implemented method, comprising:
determining, via a processor, a location of a vehicle traveling along a vehicle run;
selecting, via the processor, a set of objects based on the determined location;
displaying, on a display device, via the processor, the selected set of objects; and
providing, on the display device, via the processor, a user interface to receive input related to each of the objects in the set of objects.

2. The computer-implemented method of claim 1, wherein each object in the set of objects represents a person to board the vehicle, the method further comprising:
receiving input related to one or more of the objects in the set of objects, the input indicating the person boarded the vehicle.

3. The computer-implemented method of claim 2, wherein the input is received via the user interface,

4. The computer-implemented method of claim 2, wherein the input is received from an identification reader.

5. The computer-implemented method of claim 2, the method further comprising:
determining a subset of the set of objects representing people that did not board the vehicle: and
transmitting the subset of objects to an administrative device.

6. The computer-implemented method of claim 2, further comprising:
receiving input from an identification reader, the input identifying a person that is not included in the set of objects;
determining whether the person is in a set of objects for any of the locations along the vehicle run; and
transmitting an alert to an administrative device if the person is not in the set of objects for any of the locations along the vehicle run.

7. The computer-implemented method of claim 2, further comprising:
receiving input from an identification reader, the input identifying a person that is not included in the set of objects;
determining whether the person is in a set of objects for any of the locations along the vehicle run; and
when it is determined that the person is in the set of objects for any of the locations along the vehicle run, storing an indication that the person boarded the vehicle at the location of the vehicle.

8. An apparatus, comprising:
a storage to store a plurality of sets of objects, each of the objects representing a person and each of the objects associated with a location;
a tracking module to track whether each of the objects boards a vehicle at the location associated with each of the objects;
an interface to display a set of objects associated with a location of a vehicle and to receive an indication indicating one or more objects have boarded the vehicle; and
a processor to execute the tracking module and the interface.

9. The apparatus of claim 8, wherein he indication is received from an identification reader.

10. The apparatus of claim 8, wherein the indication is received via the interface.

11. The apparatus of claim 8, further comprising:
an exception module to store an exception when a person boards the vehicle
at a location that is different than the location associated with the person.

12. The apparatus of claim 8 wherein the exception module is further to
determine whether a location associated with a person who boarded the vehicle is a location along a run of the vehicle; and
transmit an alert when it is determined that the location associated with the person who boarded the vehicle is not along a run of the vehicle.

13. The apparatus of claim 8, further comprising:
a transmission module to transmit to an administrative device a list of ail of the people who boarded the vehicle along a run.

14. The apparatus of claim 8, wherein he tracking module includes
a selection module to select a set of objects associated with a location of a vehicle, the set of objects to be displayed on a display via the interface.

15. A non-transitory computer-readable medium, storing a set instructions, executable by a processor, to:
manage a status of a plurality of sets of objects, each of the objects representing a person scheduled to board a vehicle, wherein the status of the object indicates whether the person boarded the vehicle and, if the person boarded the vehicle, where the person boarded the vehicle; and
provide an interface to display a set of objects based on a location of the vehicle, the interface configured to receive an indication of an object in the set of objects when the person boarded the vehicle.

16. The non-transitory computer-readable medium of claim 15, the set of instructions further to:
receive input from an identification reader, the input associated with one of the objects in the set of objects associated with the location of the vehicle, the input indicating the person boarded the vehicle.

17. The non-transitory computer-readable medium of claim 15, the set of instructions further to:
determine a subset of the set of objects representing people that did not board the vehicle; and
transmit the subset of objects to an administrative device.

18. The non-transitory computer-readable medium of claim 15, the set of instructions further to:
receive input from an identification reader, the input identifying a person that is not included in the set of objects;
determine whether the person is in a set of objects for any of the locations along a vehicle run; and
transmit an alert to an administrative device if the person is not in the set of objects for any of the locations along the vehicle run.

19. The non-transitory compute readable medium of claim 15, the set of instructions further to:
receive input from an identification reader, the input identifying a person that is not included in the set of objects;
determine whether the person is in a set of objects for any of the locations along a vehicle run; and
when it is determined that the person is in the set of objects for any of the locations along the vehicle run, store an indication that the person boarded the vehicle at the location of the vehicle.

20. The non-transitory computer-readable medium of claim 15, the set of instructions further to:
transmit the status of the plurality of sets of objects to an administrative device.
